(19) United States
(12) Patent Application Publication
(10) Pub. No.: US 2022/0349490 A1
(43) Pub. Date: Nov. 3, 2022

(54) ACOUSTIC DEVICE WITH SMA MICROSPRING SWITCH

(71) Applicant: SONOVA AG, Staefa (CH)

(72) Inventors: Anna Glazer, Delft (NL); Krisztián Képíró, Delft (NL); Engbert Wilmink, Delft (NL); Nishant Shankar Lawand, Delft (NL)

(21) Appl. No.: 17/866,086

(22) Filed: Jul. 15, 2022

Related U.S. Application Data
(63) Continuation-in-part of application No. PCT/EP2021/052599, filed on Feb. 4, 2021.

(30) Foreign Application Priority Data
Feb. 5, 2020 (NL) 2024842

(51) Int. Cl. F16K 31/02; F03G 7/06; F16K 47/00; F16K 1/14; H04R 1/10

(52) U.S. Cl. CPC F16K 31/025; F03G 7/06143; F16K 47/012; F03G 7/064; F16K 1/14; H04R 1/1041; F03G 7/062

(57) ABSTRACT

An acoustic device may include a housing; an acoustic channel for passing sound through the housing; a valve seat arranged in the acoustic channel; a valve member configured to control the passing of sound through the channel depending on a configuration of the valve member with respect to the valve seat; an actuator comprising a first SMA wire section and a second SMA wire section configured to actuate the valve member and to change a configuration of the valve member with respect to the valve seat from an open configuration to a closed configuration and vice versa, respectively, when activated; and a retention mechanism which is configured to provide a retention force for retaining the valve member in the closed configuration, wherein the retention force is configured to be overcome by the actuator such that the valve member is released from the closed configuration upon activation of the actuator.

### RELATED APPLICATIONS

This application is a continuation-in-part of International Patent Application No. PCT/EP2021/052599, filed Feb. 4, 2021, which claims priority to Netherlands Patent Application No. 2024842, filed Feb. 5, 2020, each of which is hereby incorporated by reference in its entirety.

### BACKGROUND INFORMATION

In the field of hearing and audio, various acoustic devices exist which can be used, e.g., to protect, enhance and/or enable users to have a normal or better hearing experience. Examples of such acoustic devices may include hearing protection devices, hearing instruments, hearing aids, hearables, et cetera. Depending on the type, the acoustic devices can be placed at different positions in and around the human ear/canal. For example, acoustic devices can take the form of ear buds or head phones.

Typically, an acoustic device comprises one or more channels which can be used to form a connection between the ear canal and external surroundings. In some cases, the channel may help to prevent a feeling of occlusion, e.g. by allowing sound to travel from the ear drum to the external environment or vice versa. In other or further cases, the channel may act as a vent, e.g. to provide ventilation inside the ear canal and/or relieve static pressure in the ear canal.

An acoustic valve can be used to control the sound or air passing in and out of the system. For example, the valve can be installed in the channel or vent. In some cases, the acoustic valve can be switched between different states, e.g. based on one or more control parameters or other conditions. For example, an open state can be uses in situations where the natural sound (including directionality) is preserved thus getting rid of the occlusion to a certain extent by allowing sound to escape from the ear canal. It allows free flow of ear, hence offers ventilation and occlusion reduction. For example, a closed state provides a seal from the external environment to create an enhanced sound quality (in comparison with the open state) for low frequencies from the sound source (for e.g. Balanced Armature Receivers or Dynamic drivers). In addition to this directionality and noise suppression can also be achieved in this state.

As background, various types of acoustic devices, channels, and valves are described, e.g., in U.S. Pat. No. 8,798,304B2, WO2008/086188A1, U.S. Pat. No. 8,923,543B2, WO2011149970A1, US20160255433A1, US20190106416A1, US20190106436A1, US20190106438A1, EP3169290B1, US20190320272A1, US2014/0169603A1, U.S. Pat. No. 6,549,635B1.

For example, US2014/0169603A1 describes techniques for actuating a valve of a hearing assistance device. In one example, a hearing assistance device comprises a device housing defining a vent structure, a vent valve positioned within the vent, the vent valve having first and second states. The vent valve comprises a magnet, a disk configured to move about an axis, and a magnetic catch. The hearing assistance device further comprises an actuator, and a processor configured to provide at least one signal to the actuator to cause the disk to move to controllably adjust the vent structure. In some embodiments, the actuator can be a coil. In other example implementations, the actuator can be an electroactive polymer, a shape memory alloy, piezoelectric element, or a flexible polymer that comprises magnetic material, for example.

There is a need for further improvement in acoustic devices, e.g. with an acoustic valve that is reliable with low power consumption.

### SUMMARY

An aspect of the present disclosure relates to an acoustic device comprising a housing and an acoustic channel for passing sound through the housing. The acoustic device comprises an acoustic valve with a valve seat and a valve member. The valve seat is arranged in the acoustic channel. The valve member is configured to determine and control the passing of sound through the acoustic channel depending on its configuration, e.g. depending on a configuration of the valve member with respect to the valve seat. For example, the valve member can move and/or reshape while the valve seat stays in place, e.g. as part of the channel.

The valve seat hereby refers to a structure of the acoustic valve that has an opening for the passing of sound and which is configured for the valve member to interact with in order to close the opening for preventing the passing of sound in the closed configuration. The valve member may for example rest against the valve seat in the closed configuration to prevent the passing of sound through the opening of the valve seat. The valve seat may for example comprise a contact surface against which the valve member may rest with a corresponding contact surface in the closed configuration. In some embodiments, the valve seat may comprise a receptacle with a shape complementary to a part of the valve member, for example formed by a partial impression of the valve member, such that the valve member may be at least partially inserted into the valve seat to close the opening of the valve seat in the closed configuration.

The acoustic device comprises an actuator with at least a first SMA wire section and a second SMA wire section. The first SMA wire section and the second SMA wire section may be provided in the form of a filament or may have a strip-like shape. The first SMA wire section and the second SMA wire section are configured to actuate the valve member and to change the configuration of the valve member from an open configuration to a closed configuration and vice versa, respectively, when activated. For example, the first SMA wire section is configured to change the configuration of the valve member from the open configuration to the closed configuration when activated and the second SMA wire section may be configured to change the configuration from the closed configuration to the open configuration when activated. The SMA wire sections may be selectively activatable. The acoustic device further comprises a retention mechanism which is configured to provide a retention force for retaining the valve member at least in the closed configuration. The retention force is configured to be overcome by the actuator, e.g. by the second SMA wire section, such that the valve member is released from the closed configuration upon activation of the actuator.

In some embodiments, the acoustic device of the disclosure may comprise more than one acoustic channel with one or more of the acoustic channels having an acoustic valve as described herein.

Another aspect of the present disclosure relates to an acoustic device comprising a housing and an acoustic channel for passing sound through the housing. The acoustic device comprises an acoustic valve with a valve seat and a valve member. The valve seat is arranged in the acoustic channel. The valve member is configured to determine and control the passing of sound through the acoustic channel depending on its configuration, e.g. depending on a configuration of the valve member with respect to the valve seat. The acoustic device includes an actuator comprising an at least partially coiled-up SMA wire configured to actuate the valve member and to change the configuration of the valve member, e.g. with respect to the valve seat, from an open configuration to a closed configuration and vice versa when activated.

Another aspect of the present disclosure relates to a method for operating an acoustic device, the method comprising providing, by a controller unit, a first electric control signal to a first SMA wire section of an actuator of the acoustic device which is connected to a valve member to actuate the valve member to change into a closed configuration, e.g. with respect to a valve seat. The method further comprises providing, by the controller unit, a second electric control signal to a second SMA wire section of the actuator of the acoustic device which is connected to the valve member to actuate the valve member to change into the open configuration, e.g. with respect to the valve seat. The changing into the open configuration for example includes the valve member to be released from the closed configuration by overcoming a retention force provided by a retention mechanism of the acoustic device.

Another aspect of the present disclosure relates to a method for operating an acoustic device, the method comprising providing, by a controller unit, an electric control signal to an at least partially coiled-up SMA wire of an actuator of the acoustic device which is connected to a valve member to actuate the valve member to change a configuration of the valve member with respect to a valve seat from an open configuration to a closed configuration and vice versa.

### BRIEF DESCRIPTION OF THE DRAWINGS

These and other features, aspects, and advantages of the apparatus, systems and methods of the present disclosure will become better understood from the following description, appended claims, and accompanying drawing wherein:

FIGS. 1A and 1B illustrate an acoustic device wherein a ball shaped valve member cooperates with a ring shaped valve seat to form an acoustic valve;

FIGS. 2A and 2B illustrate an acoustic device wherein the valve seat is relatively thin forming flexible washer;

FIGS. 3A and 3B illustrate a valve member having an outer rim cooperating with a ridged valve seat;

FIGS. 4A and 4B illustrates multiple SMA wires to actuate the valve member;

FIGS. 5A and 5B illustrate a ring shaped valve member actuated by SMA wires to cooperate with a ball shaped valve seat;

FIGS. 6A and 6B illustrate a deformable cup shaped valve member being actuated with respect to the valve seat forming a rim around the cup shape;

FIGS. 7A and 7B illustrate photographs of a deformable cup shaped valve member and corresponding valve seat;

FIGS. 8A and 8B illustrate acoustic measurements of an acoustic device according to FIGS. 1A and 1B;

FIGS. 9A and 9B illustrate an acoustic device with a bi-stable acoustic valve having a disk shaped valve member comprising a permanent magnet;

FIG. 10 illustrates another acoustic device with an acoustic valve having a disk shaped valve member comprising a permanent magnet;

FIG. 11 illustrates an acoustic device with a bi-stable acoustic valve having a disk shaped valve member comprising a permanent magnet, wherein the disk-shaped valve member is actuated via an actuator linkage;

FIGS. 12A and 12B illustrate an acoustic device with a bi-stable acoustic valve having a valve member which is displaceable transversely to a direction of a sound channel to change its configuration.

### DETAILED DESCRIPTION

The present disclosure relates to an acoustic device, e.g. having or forming an acoustic valve, and method of controlling the device.

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

In an embodiment, the first SMA wire section and/or the second SMA wire section is coiled to form a respective micro spring, wherein a distance between end points of the coiled part of the respective SMA wire section is less than an uncoiled length of the respective SMA wire section, by at least a factor three.

In an embodiment, different parts of a single SMA wire form the first and the second SMA wire section. Thereby, the single SMA wire may pass through the valve member. In an embodiment, the first and the second SMA wire section may be arranged on either side of the valve member. In another embodiment, the first and the second SMA wire sections may be arranged on the same side of the valve member.

In an embodiment, the at least one SMA wire may be electrically conductive, wherein a first electric terminal may be connected to the at least one SMA wire in a section between the first SMA wire section and the second SMA wire section, and a second electric terminal may be connected to an end of the first SMA wire section forming a first electrical path between the first electric terminal and the second electric terminal through the first SMA wire section, and a third electric terminal is connected to an end of the second SMA wire section forming a second electrical path between the first electric terminal and the third electric terminal through the second SMA wire section.

In an embodiment, the first SMA wire section and/or the second SMA wire section are directly connected to the valve member. In another embodiment, the valve member can be connected to the first SMA wire section and/or the second SMA wire section via an actuator linkage which may be provided for example by a connecting structure in the form of e.g. a push/pull rod or an actuation lever.

In an embodiment, multiple SMA wire sections may be disposed on each side of the valve member.

In an embodiment, the acoustic device comprises a set of electric terminals which is configured to supply an electric current to the actuator for its activation. Thereby, for example, the first SMA wire section and the second SMA wire section are electrically conductive and the set of electric terminals is connected to the first SMA wire section and the second SMA wire section in a manner to allow for selectively passing an electric current through the respective SMA wire section.

In an embodiment, the first SMA wire section and the second SMA wire section each is configured to contract or extend depending on their temperature determined by an electrical current that may be provided to them via electric terminals to exert an actuation force on the valve member. For example, the SMA wire sections and a set of electric terminals are configured to selectively heat either one of the SMA wire sections when an electric current is applied at the set terminals and passed through the respective SMA wire section to cause contraction in the heated wire section, wherein the contraction causes an actuation force which pulls the valve member towards the closed configuration when the first SMA wire section is heated or towards the open configuration when the second SMA wire section is heated.

In an embodiment, the valve member and/or the valve seat comprise an elastic damping material at least on surfaces which come into contact in the closed configuration. In other embodiments, the contact surfaces that come into contact with a stopper and/or the corresponding contact surfaces of the stopper may comprise an elastic damping material. In other embodiments, the whole valve member and/or the whole valve seat may be coated with an elastic damping material. Such elastic damping materials may reduce disturbing or irritating impact noises of the acoustic valve assembly.

In an embodiment, the retention mechanism is configured to provide the retention force for retaining the valve member in the closed configuration by a contact force between the valve member and the valve seat. In this case, for example, at least one of the valve member and valve seat comprises an elastic material, and the valve member is dimensioned to at least partially pass through an opening formed by the valve seat, or vice versa, by compressing the elastic material when the at least one SMA wire, in particular a first SMA wire section, is activated to change to a closed configuration. The contact force between the valve seat and valve member is thereby caused by the compressed elastic material pushing to re-expand there between. In an embodiment, at least one of the valve member and valve seat may comprise the elastic material with a Young's modulus of less than two hundred Mega Pascal, and the other of the valve member and valve seat comprises a rigid material with a Young's modulus of more than four hundred Mega Pascal.

In an embodiment, the valve member is formed as a ball with a diameter of less than three millimeter, wherein the valve seat forms an opening with an inner diameter equal to or up to ten percent smaller than an outer diameter of the valve member, wherein the acoustic channel has an inner cross-section diameter larger than an outer diameter of the valve member by at least twenty percent. In another embodiment, the valve member may be formed as a disk and the valve seat may have a ring shape.

In an embodiment, the valve seat comprises a ring having an inner diameter and a thickness configured to cause the valve member to remain stuck therein when the first wire section is activated to pull the valve member towards the closed configuration, and get unstuck when the second wire section is activated to pull the valve member towards the open configuration. The valve seat may for example comprise a washer configured to deform and allow a center of the valve member to pass there through.

In an embodiment, the valve member may be formed as a cup which is connected to the valve seat, wherein the cup folding inward or outward changes the configuration of the acoustic channel between the closed configuration and open configuration. In some embodiments, the cup may include a magnet or a magnetizable structure configure to interact with a magnet or a magnetizable structure of the valve seat at least in the closed configuration. The magnet or magnetizable structure of the cup may for example be formed by a coating of the cup, the coating comprising a magnetic or magnetizable material.

In an embodiment, the retention mechanism comprises a magnet or magnetizable structure fixedly arranged in relation to the valve seat which is configured to interact with a corresponding magnet or magnetizable structure of the valve member at least in the closed configuration. For example, the valve member may comprise a permanent magnet and the valve seat may comprise a soft magnetic alloy, i.e. an easily magnetizable alloy, as a corresponding magnetizable structure. In an embodiment, the valve member comprises a disk shaped permanent magnet and the valve seat comprises a structure which is made from a soft magnetic alloy and which has a ring-shaped contact surface for abutment of the valve member in the closed configuration. In an embodiment, the housing of the acoustic device may be made from a soft magnetic material in order to provide for magnetic shielding on the one hand and, on the other hand, to allow for a simple way to provide for magnetizable structure which can be directly formed as part of the housing.

In an embodiment, the retention mechanism is configured to provide a second retention force for retaining the valve member in the open configuration, wherein the second retention force is configured to be overcome by the actuator such that the valve member is released from the open configuration upon activation of the actuator. In this case, the aforementioned retention force for retaining the valve member in the closed configuration may also be referred to as a “first” retention force. For example, the retention mechanism may comprise first magnet or magnetizable structure fixedly arranged in relation to the valve seat, and a second magnet or magnetizable structure fixedly arranged in relation to the valve seat. The first magnet or magnetizable structure and the second magnet or magnetizable structure may thereby be configured to magnetically interact with one or more magnets or magnetizable structures of the valve member in order to provide for the, in this case first, retention force in the closed configuration and for the second retention force in the open configuration, respectively.

In an embodiment, a method for operating the acoustic device for example comprises providing, by a controller unit, a first electric control signal to a first SMA wire section of an actuator of the acoustic device which is connected to a valve member to actuate the valve member to change into a closed configuration with respect to a valve seat, and providing, by the controller unit, a second electric control signal to a second SMA wire section of the actuator of the acoustic device which is connected to the valve member to actuate the valve member to change into the open configuration with respect to the valve seat. Thereby, the changing into the open configuration involves the valve member to be released from the closed configuration by overcoming a retention force provided by a retention mechanism of the acoustic device.

In an embodiment, an acoustic device comprises for example a housing, an acoustic channel for passing sound through the housing, a valve seat arranged in the acoustic channel, a valve member configured to determine the passing of sound through the channel depending on a configuration of the valve member with respect to the valve seat. At least one SMA wire is configured to actuate the valve member and switch the configuration. A set of electric terminals, e.g. connection points or wires, are configured to supply electric power for the activation of a first section of the at least one SMA wire. In this way the switching of the configuration can be controlled. By providing a relatively soft or elastic material between the interfaces of the valve member and valve seat, this material can be compressed. By compressing the elastic material the valve member can at least partially pass through an opening formed by the valve seat, or vice versa. For example, a first wire section of the SMA wire is activated to switch to a closed configuration and a second SMA wire is activated to switch to an open configuration. Advantageously, the closed configuration can be maintained by a contact force between the valve seat and valve member caused by the compressed elastic material pushing to re-expand there between. The valve member can be released from the closed configuration by overcoming the contact force when the second wire section is activated to switch to the open configuration. Accordingly, the valve can remain reliably closed (or open) without power to the SMA wire.

In an embodiment, the at least one SMA wire is at least partially formed as at least one SMA (micro)spring. The SMA (micro)spring(s) forms a mechanical valve e.g. comprising a hard polymer type of a sphere being locked in a soft polymer material type of ring. This type of construction with combination of soft and hard material may provide a good sealing of the valve in a closed state and allow relatively free sound passage in an open state. It may also prevents leakage due to relaxation of the SMA (micro)spring. The whole module can be light-weight and miniaturized so that it can fit in an ear tip.

In an embodiment, the acoustic device comprises a set of electric terminals configured to supply electric power for the activation of the respective SMA wire section to control the switching of the configuration wherein at least one of the valve member and valve seat comprises an elastic material, wherein the valve member is dimensioned to at least partially pass through an opening formed by the valve seat, or vice versa, by compressing the elastic material when a first wire section of the SMA wire is activated to switch to a closed configuration, wherein the closed configuration is maintained by a contact force between the valve seat and valve member caused by the compressed elastic material pushing to re-expand there between, and wherein the valve member is released from the closed configuration by overcoming the contact force when a second wire section is activated to switch to an open configuration.

In an embodiment, the at least one SMA wire is electrically conductive and the electric terminals are connected to selectively pass an electric current through a respective wire section of the SMA wire.

In an embodiment, the at least one SMA wire is activated by a controller supplying an electric current via a respective set of terminals for actuating the valve member, wherein the respective SMA wire section is configured to contract or extend depending on its temperature determined by the electrical current to exert an actuation force by its connection to the valve member.

In an embodiment, the valve seat comprises a set of ridges and the valve member comprises a rim configured to get stuck in a respective ridge when the valve member is at least partially passed through the valve seat, or vice versa.

In an embodiment of the disclosure, a method of controlling the acoustic device comprises generating a first control signal to activate the first wire section to pass the valve member at least partially through an opening formed by the valve seat, or vice versa, by compressing elastic material there between, wherein the closed configuration is maintained by a contact force between the valve seat and valve member caused by the compressed elastic material pushing to re-expand there between. The method further comprising generating a second control signal to activate the second wire section to release the valve member from the closed configuration by overcoming the contact force when a second wire section is activated to switch to an open configuration.

The embodiments are described more fully hereinafter with reference to the accompanying drawings. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

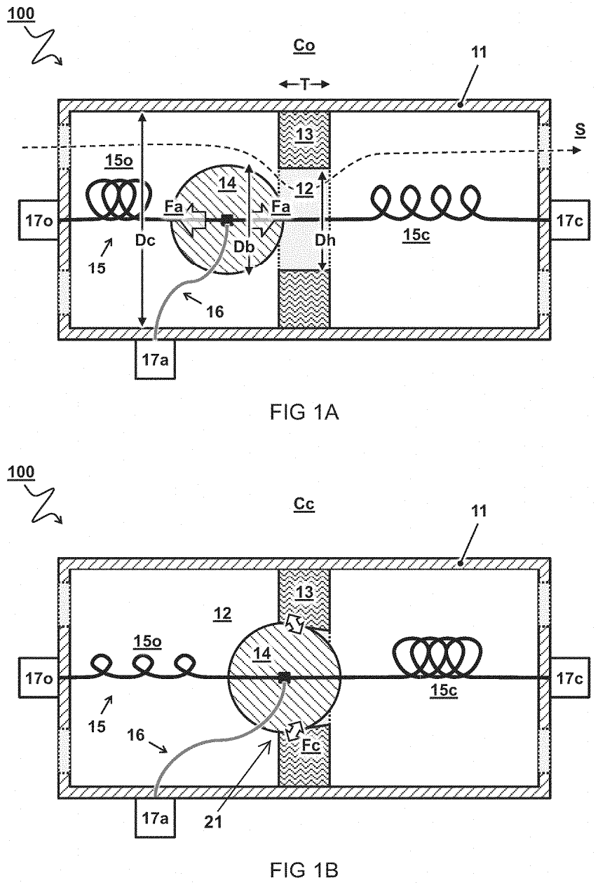

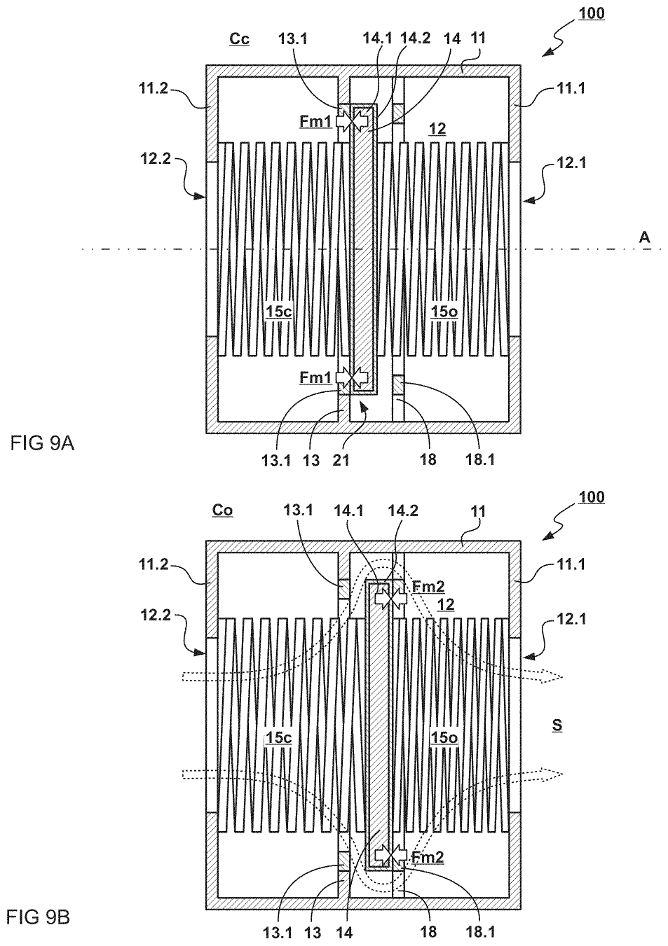

FIGS. 1-6 as well as FIGS. 9 to 12 illustrate various acoustic devices 100 in respective open and closed configurations Co and Cc.

Typically, the acoustic device 100 comprises a housing 11 with an acoustic channel 12 for passing sound S there through. As described herein, a valve seat 13 is arranged in the acoustic channel 12 and a valve member 14 is configured to determine the passing of sound through the channel 12 depending on the relative configuration, thus forming an acoustic valve in the acoustic channel 12. A first SMA wire section 15c and a second SMA wire section are configured to actuate the valve member 14. In an embodiment, the first and the second SMA wire section can be provided by at least one SMA wire 15. For example, the wire can actuate valve member 14 to switch the configuration when a respective SMA wire section 15o,15c of the at least one SMA wire 15 is activated. A set of electric terminals 17 can be used to supply electric power for the activation of the respective SMA wire section 15o,15c to control the switching of the configuration Co and/or Cc.

In some embodiments, at least one of the valve member 14 and valve seat 13 comprises an elastic material. In other or further embodiments, the valve member 14 is dimensioned to at least partially pass through an opening formed by the valve seat 13, or vice versa. In some embodiments, the valve member may be passed through or past the valve seat by compressing the elastic material. For example, this can happen when a first wire section 15c of the SMA wire 15 is activated to switch to a closed configuration Cc. In some embodiments, the closed configuration Cc is maintained by a contact force Fc between the valve seat 13 and valve member 14 caused by the compressed elastic material pushing to re-expand there between. The valve seat 13 and the valve member 14 with the elastic material thereof thus provide for a retention mechanism 21 which retains the valve member 14 in the closed configuration Cc. For example, the valve member 14 is released from the closed configuration Cc by overcoming the contact force Fc when a second wire section 15o is activated to switch to an open configuration Co.

As described herein, the SMA wire comprises or essentially consists of a shape-memory alloy SMA material. SMA material also referred to as smart metal, memory metal, memory alloy, muscle wire, smart alloy is an alloy that “remembers” its original shape and that when deformed may return to its pre-deformed shape when activated. For example, the SMA wire comprises or essentially consists of a Ni—Ti alloy, Cu—Zn—Al alloy, Cu—Al—Ni alloy, or any other material acting as an SMA. SMA material may provide a lightweight, solid-state actuator as an alternative to conventional actuators such as piezo, hydraulic, pneumatic, and motor-based systems.

Typically, the SMA wire is affected by temperature. For example, a relatively high temperature, in particular a temperature above a transition temperature of the respective SMA material, may cause the wire to contract or to expand, depending on how the SMA wire sections are configured and whether the “remembered” shape is the contracted or the expanded state, respectively. In embodiments where the SMA wire sections are at least partially coiled-up into a (micro) spring, the spring may thus, depending on the SMA wire configuration, contract (tensile spring) for exerting a tensile force or expand (compression spring) for exerting a compressive force when heated.

When the element cools down it may reach a relatively low stabilization temperature, e.g. at ambient temperature. In some cases, this may cause at least some extension of the wire length. Accordingly, a length of the SMA wire may be related to its temperature. The SMA wire may be provided with heat according to some embodiments. This may cause the wire to attain an elevated temperature. For example, the SMA wire can be heated to at least fifty degrees Celsius, for example in a range between sixty and hundred twenty degrees Celsius, e.g. ninety degrees Celsius. The elevated temperature may cause the wire to contract to a heated contraction length, e.g. regain its original (“remembered”) shape after having previously been extended. Accordingly, mechanical movement can be provided to the valve member 14 to another position.

In an embodiment, the heated contraction length of a respective wire section is shorter than its stabilized extended length by at least one percent, at least two percent, or at least three percent, or more. The more the relative contraction, the less limited the mechanical stroke which can be provided. In some embodiments, the absolute contraction may also be improved by lengthening the SMA wires, e.g., by coiling the wire. In some embodiments, the combination of the SMA wire length and relative contraction provides a mechanical stroke of at least hundred micrometer, e.g., at least half a millimeter or even more than one millimeter.

In some embodiments, the at least one SMA wire 15 or the first SMA wire section 15c and/or the second SMA wire section 15o is coiled. When coiled, the length (distance between end points) can be much shorter than its uncoiled length, e.g. by at least a factor two, three, four, five, or more. For example, the coiling may increase stroke. Alternatively, or additionally the SMA wire 15 or the SMA wire sections 15o, 15c can form a (micro) spring capable of exerting resilient force. Typically, the total SMA wire, or the respective SMA wire section 15o,15c each, has an uncoiled length between ten and fifty millimeter, e.g. twenty five millimeter. For example, the total SMA wire, or the respective SMA wire section 15o,15c each, has a coiled length between four and twelve millimeter, e.g. six millimeter. When activated, e.g. by heat, wherein the SMA wire (distance between points) may typically shorten by at least one, two, or three percent of the uncoiled length and/or by at least five, ten, fifteen, or even twenty percent of the coiled length (distance).

After heating the wire may lose at least part of its heat so it may cool down to a stabilization temperature, which may be the same or different from the initial temperature. For example, cooling can be effected by radiation, convection, or conduction, which may cause partial relaxation of the contraction, i.e. re-extension of the respective wire section. As described herein, the valve member 14 may be kept in (closed) position against the valve seat 13 by the elastic material there between, despite the relaxation of the SMA wire.

In some embodiments, the SMA wire, or parts thereof, are activated electrically, e.g. wherein an electric current results in Joule heating. The heat can e.g. be supplied by an electrical current through the SMA wire, electric wire contacting the SMA wire, or any other heating and/or cooling element, e.g. proximate to, adjacent, or contacting the SMA wire (not shown). Deactivation typically occurs by free convective heat transfer to the ambient environment. In some cases, SMA material may exhibit hysteresis, i.e. a dependence of the state of the system on its history. In an embodiment, the at least one SMA wire 15 is electrically conductive and the electric terminals 17 are connected to selectively pass an electric current through a respective wire section 15o,15c of the SMA wire 15.

In some embodiments, the acoustic device 100 comprises or is coupled to a controller (not shown). For example, the at least one SMA wire 15 is activated by a controller supplying an electric current via a respective set of terminals 17a,17o; 17a,17c for actuating the valve member 14, wherein the respective SMA wire section 15o,15c is configured to contract or extend depending on its temperature determined by the electrical current to exert an actuation force Fa by its connection to the valve member 14.

Aspects described herein can also be embodied as a method for controlling an acoustic device 100 as described herein. In some embodiments, a first control signal is generated to activate the first wire section 15c to pass the valve member 14 at least partially through an opening formed by the valve seat 13, or vice versa, by compressing elastic material there between. In some embodiments, the closed configuration Cc is maintained by a contact force Fc between the valve seat 13 and valve member 14 caused by the compressed elastic material pushing to re-expand there between. In other or further embodiments, a second control signal is generated to activate the second wire section 15o to release the valve member 14 from the closed configuration Cc by overcoming the contact force Fc when a second wire section 15o is activated to switch to an open configuration Co. For example, the control signals are generated by the controller. Alternatively or additionally, aspects can be embodied as a non-transitory computer-readable medium storing instructions that, when executed by one or more processors, cause a device to perform the method as described herein.

In some embodiments, the SMA wire 15 is configured to change, by pulling on the valve member 14, the configuration of the acoustic device 100 between at least an open configuration Co wherein the channel 12 for the passage of sound S through the housing 11 is relatively open and a closed configuration Cc wherein the channel 12 is relatively restricted (partially or fully closed). Also other or further states can be defined, e.g. one or more intermediate states allowing various degrees of attenuation. Alternatively, or in addition to varying attenuation, the set of states may also include different filtering of sound, e.g. wherein a first state has a different sound transmission characteristic than a second state. For example, the moving valve member 14 can open or close different passages with different filters.

In some embodiments, a bi-stable (or multi-stable) actuator is desired, that is, an actuator that can move between two or more positions and remain at any of those without consuming power. In some embodiments, this is achieved by creating an actuator based on antagonist respective SMA wire sections 15o,15c which act against each other. When one contracts, the other one elongates and is ready to be contracted. The contracting SMA wire can be used to pull on the valve member 14 in either direction. Then, the elongated wire section is ready to contract as it is activated e.g. by passing electricity there through, thus moving the valve member 14 to the one side and elongating the other wire section. This mechanism can be bi-stable and used cyclically.

In an embodiment, the acoustic device 100 comprises at least two SMA wire sections 15o,15c with respective sets of control terminals 17a,17o; 17a,17c configured to the selectively heat either one of the SMA wire sections 15o,15c to cause contraction in the heated wire section, wherein the contraction causes an actuation force Fa by pulling the valve member 14 in one of at least two different directions towards the closed configuration Cc or the open configuration Co depending on which wire section is heated. For example, the actuation mechanism of the acoustic valve, e.g. valve member 14, respective controllers or switches connected to the respective terminals and configured to the selectively activate (e.g. heat by electricity) either one of the respective SMA wire sections 15o,15c.

In some embodiments, a first electric terminal 17a is connected, e.g. by a respective electric wire 16, to a respective wire section of the at least one SMA wire 15 at the valve member 14 and/or between the first and second sections 15o,15c. In other or further embodiments, a second electric terminal 17c is connected to an end of the first wire section 15c forming a first electrical path between the first electric terminal 17a and the second electric terminal 17c through the first wire section 15c. In other or further embodiments, a third electric terminal 17o is connected to an end of the second wire section 15o forming a second electrical path between the first electric terminal 17a and the third electric terminal 17o.

In some embodiments, the respective SMA wire sections 15o,15c may comprise separate SMA wires, e.g. each connected with a respective electric wire 16. In other or further embodiments, different parts of a single SMA wire 15 form the first and second wire sections 15c on either side of the valve member 14. For example, the same electric wire 16 may be connected to a middle of the single SMA wire 15 and conduct a current in either directions of the respective SMA wire sections 15o,15c, e.g. depending on a switching or voltage at the other terminal 17o,17c.

In other or further embodiments, the (single) SMA wire passes through the valve member 14. Typically, the at least one SMA wire may also pass through the valve seat 13 and/or opening there through. For example, the valve member 14 is disposed in the channel 12 hanging by the at least one SMA wire 15. Also other or further support structures can be envisaged. For example, the valve member 14 can be attached to a guidance structure, e.g. one or more further support wires (not shown). In one embodiment, the guidance structure can be used to guide the valve member 14 along a specific trajectory as it is actuated by the respective SMA wire sections 15o,15c. For example, the valve member 14 may slide along a guide wire (not shown) through the valve member 14 and/or through the opening in the valve seat 13.

With reference now to material properties, in some embodiments the elastic material is configured to recover a specific form in the absence of external forces. A temporary shape change that is self-reversing after the force or stress is removed, so that the object returns to its original shape, can be referred to as elastic deformation e.g. as opposed to plastic deformation. In other words, elastic deformation may refer to a change in shape of a material that is recoverable after the force is removed. So the one or both of the valve seat 13 and/or valve member 14 may comprise (e.g. is covered by) or essentially consists of an elastically deformable material.

In some embodiments, the elastic material is relatively flexible. The complementary concept of flexibility is stiffness, which is the extent to which an object resists deformation in response to an applied force. The more flexible the material is, the less stiff it is, i.e. the easier to deform. In some embodiments, an elastic material with relatively high flexibility may be desired. For example, the elastic material has a Young's modulus of less than four hundred Mega Pascal (MPa), e.g., less than two hundred Mega Pascal, e.g., less than one hundred Mega Pascal. The lower the Young's modulus of the elastic material, the less force or energy it may take to deform the material and push the valve member 14 into and at least partially through the valve seat 13, or vice versa.

In other or further embodiments, a certain degree of stiffness or resilience may be desired, e.g. elastic stiffness or resilience which can provide a biasing or resilient force resisting deformation and keep the valve member 14 in place. For example, the elastic material has a Young's modulus of more than one Mega Pascal, e.g., more than two Mega Pascal, more than ten Mega Pascal, more than twenty Mega Pascal, or even more than fifty Mega Pascal. For example, the elastic material comprises a resilient and/or elastic material such as soft polymer, silicone, polyurethane, or other type of elastic polymer or rubber like material. The elastic material may cause a resilient or elastic contact, e.g. friction, force which can help to maintain a position of the valve member 14 with respect to the valve seat 13, e.g. in the closed configuration Cc despite relaxation of the respective SMA wire section 15o,15c.

Additionally, or alternatively, to the resilience of the elastic materials, also other properties can play a role in the retention such as the shape and/or friction provided by the contacting surfaces. On the one hand the shape and/or friction should be sufficient to retain the closed configuration. On the other hand, the force to release the configuration should not be excessive. For example, the contact surfaces between the valve seat 13 and the valve member 14 typically have a coefficient of (static) friction between 0.2 and 0.8 or between 0.3 and 0.6 (lower is less friction).

In some embodiments, both the valve seat 13 and valve member 14 comprise elastic material. As another example, at least one of the valve member 14 or valve seat 13 comprises a relatively hard material, e.g. relatively rigid or non-elastic material, at least disposed at the respective contact interface. In one embodiment, the valve seat 13 comprises a relatively elastic material, and the valve member 14 comprises a relatively rigid material. In another or further embodiment, the valve seat 13 comprises a relatively rigid material, and the valve member 14 comprises a relatively elastic material. Using a combination of elastic and hard contact interfaces may improve performance.

In some embodiments, (at least) a contact surface of one of the valve member 14 and valve seat 13 comprises the elastic material, and a contact surface of the other of the valve member 14 and valve seat 13 comprises a relatively hard or rigid material with a Young's modulus of more than four hundred Mega Pascal, e.g., more than one Giga Pascal, e.g. up to two or three Giga Pascal, or more. Examples of such hard materials may include e.g. Polyvinylchloride (PVC), Polycarbonate (PC), Polyethylene terephthalate (PET) and other type of hard plastics or polymers.

In some embodiments, the valve member 14 is relatively light, e.g. to hang and move the valve member 14 from the respective SMA wire sections 15o,15c alone, or in combination with other support structures. For example, the valve member 14 has a mass of less than twenty grams, e.g., less than ten grams. The weight may also depend on the type of material. For example, when the valve member comprises a relatively soft or elastic material, the mass is typically between one and eight grams, e.g., between two and six grams. For example, when the valve member comprises a hard or inelastic material, the mass can be a bit higher, e.g. between two and ten grams, e.g., between three and eight grams. To fit into a miniature design, the valve member 14 typically has a diameter (Db) less than five millimeter, e.g., less than four or even less than three millimeter. In some embodiments, the diameter (Db) of the valve member 14 is between one and two-and-half millimeter.

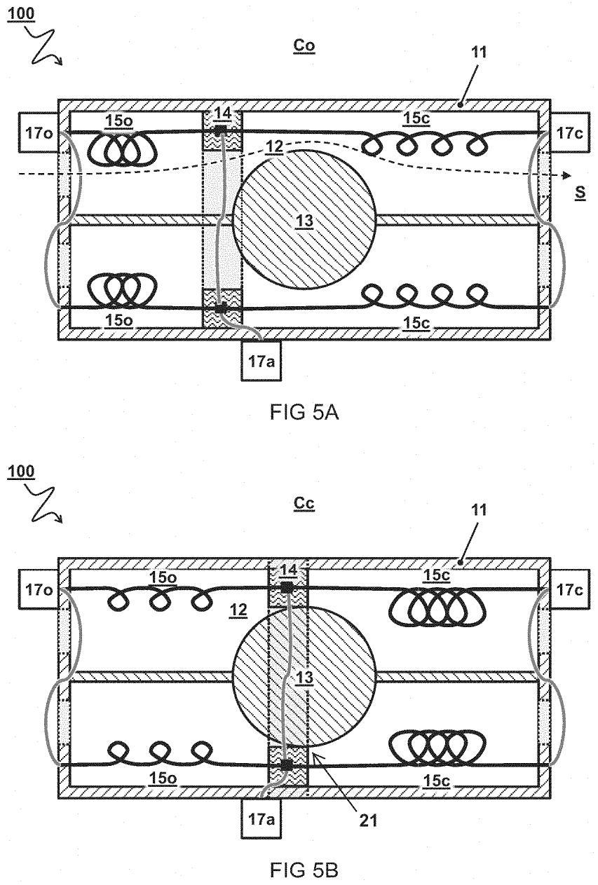

In some embodiments, the valve member 14 is formed as a ball. While the ball shape may be used for either the valve member 14 or the valve seat 13 (shown e.g. in FIG. 5) also other or further shapes can be envisaged, e.g. having rotation symmetry and/or an overall convex contour. In other or further embodiments, the valve seat 13 forms an (round) opening that is part of the acoustic channel 12. For example, the round (or oval) valve member has a diameter (in the cross-diameter direction of the hole) in the aforementioned range. In some embodiments, the opening through the valve seat 13 has an inner diameter Dh approximately equal an outer diameter Db of the valve member 14, or slightly smaller, e.g. between one and ten percent smaller. This may allow the valve member 14 to pass at least partially through the valve seat 13 while also compressing the elastic material by a few percent.

While the valve seat 13 may be dimensioned to trap or hold the valve member 14, the rest of the acoustic channel 12 can be relatively wider to allow more free movement of the valve member 14, at least on a side where the valve member 14 is disposed when in the open configuration Co. In an embodiment, the channel 12 has an inner cross-section diameter Dc larger than an outer diameter of the valve member 14 and/or inner diameter of the valve seat 13 by at least a factor 1.1, e.g., at least a factor 1.2 (twenty percent), 1.3. 1.5, or more. For example, the acoustic channel 12 has a typical diameter Dc between two and four millimeter. The channel length can be larger, e.g. by at least a factor two. For example, the channel has typical length between eight and twelve millimeter. In one embodiment, the acoustic device as described herein forms an ear plug fitting at least partially in an ear canal. For example, an outer diameter of the housing is less than two centimeters, e.g., less than one and half centimeter, such as less than one centimeter.

Reference will now be made to some specific and advantages illustrated by the respective figures. Of course, it will be understood that these features can be combined as desired to provide even further advantages.

FIGS. 1A and 1B illustrate an acoustic device wherein a ball shaped valve member 14 cooperates with a ring shaped valve seat 13 to form an acoustic valve. In some embodiments, the valve seat 13 comprises a ring having an inner diameter Dh and a thickness T configured to cause the valve member 14 to remain stuck therein when the first wire section 15c is activated to pull the valve member 14 towards the closed configuration Cc. In some embodiments, the configuration get unstuck (only) when the second wire section 15o is activated to pull the valve member 14 towards the open configuration Co. For example, the elastic material in one or both of the valve seat 13 or valve member 14 is compressed by pulling the valve member 14 into the valve seat 13. In some embodiments, the valve seat 13 has a thickness T on the order of the diameter Db of the valve seat 13, e.g. with a thickness T at least one quarter, or more than half the diameter Db. In this range, typically the valve member 14, e.g. ball, may get stuck somewhere at the start of the valve seat 13 (e.g. the center of the valve member 14 does not pass the start of the valve seat 13). In other embodiments, the ball shaped valve member 14 may comprise a magnet or a magnetizable structure which interacts with a magnet or magnetizable structure of the valve seat 13 in order to retain or to support retention of the valve member 14 in the closed configuration Cc.

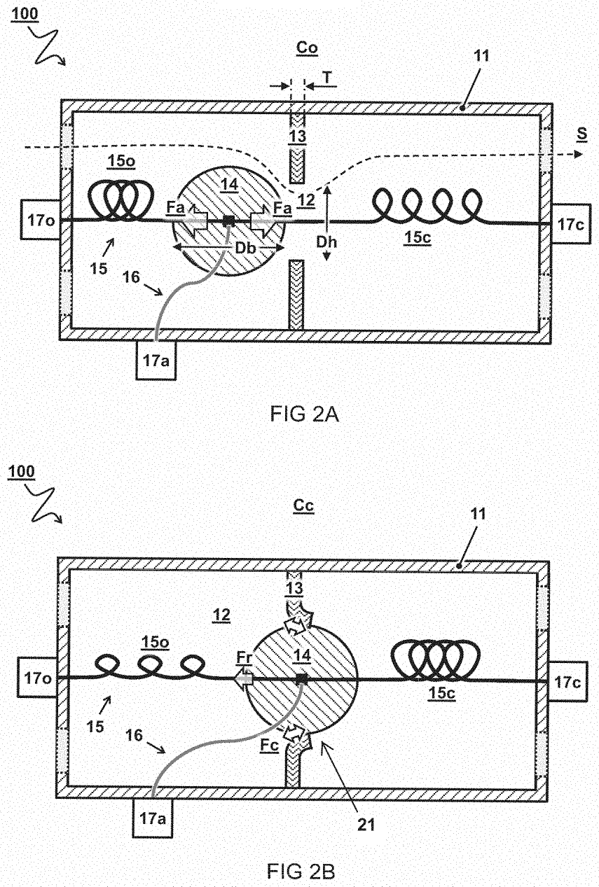

FIGS. 2A and 2B illustrate an acoustic device wherein the valve seat 13 is relatively thin forming flexible washer. In some embodiments, the valve seat 13 comprises a washer (thin ring) configured to deform and allow a center of the valve member 14 to pass there through (and get stuck when trying to pass back). For example, the elastic material of the valve seat 13 bends in one direction while passing the valve member 14 and resists bending back to keep the valve member 14 stuck (until it is released).

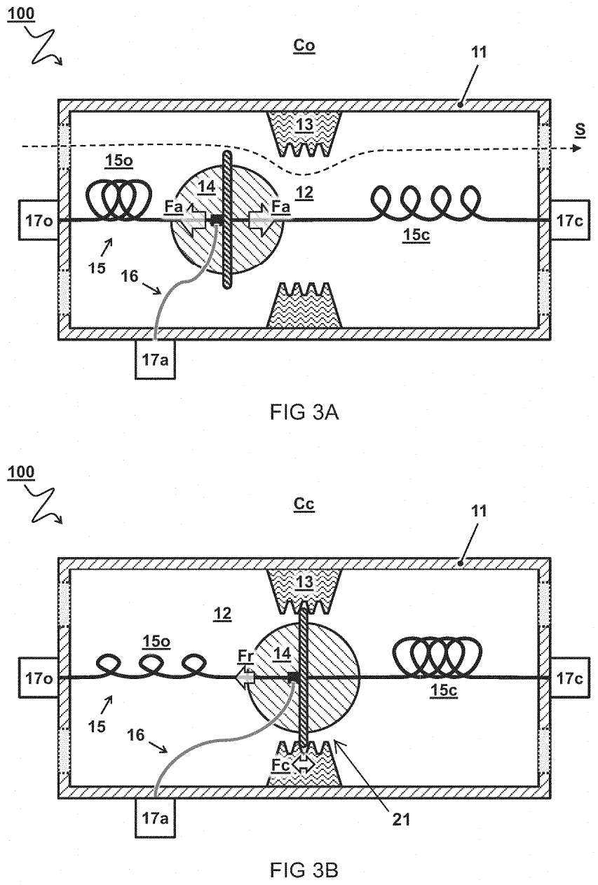

FIGS. 3A and 3B illustrate a valve member 14 having an outer rim cooperating with a ridged valve seat 13. In some embodiments, the valve seat 13 comprises a set of ridges and the valve member 14 comprises a rim (e.g. Saturn ring) that gets stuck in a respective ridge when the valve member 14 is at least partially passed through the valve seat 13, or vice versa. For example, the rim can be hard and the ridges of the valve seat 13 relatively flexible (elastic), or vice versa. Also the ridges can be disposed on the valve member 14 and the rim (or ridges) disposed on the valve seat 13. Also other inversions or variations can be envisaged.

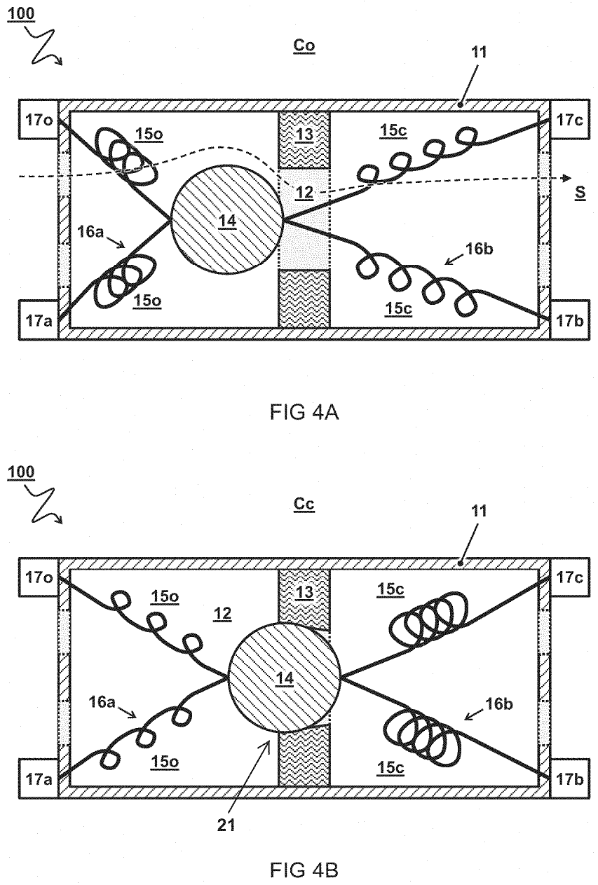

FIGS. 4A and 4B illustrates multiple SMA wires to actuate the valve member 14. In some embodiments, multiple SMA wire sections 15o,15c are disposed on each side of the valve member 14. Providing multiple wires or coils may further improve stroke. For example, a first SMA wire can be loop back from one side of the acoustic channel 12 to the valve member 14, and a (separate) second SMA wire can loop back from the opposite side of the acoustic channel 12 and the valve member 14. Accordingly, at least two lengths of SMA wire sections can be provided on either side. The SMA wire may also loop back and forth multiple times, or there can be provided a set of separate SMA wires on each side. In this and other embodiments, each SMA wire or section can have its own set of terminals 17a, 17o; 17b,17c; or some terminals can be shared.

FIGS. 5A and 5B illustrate a ring shaped valve member 14 actuated by SMA wires to cooperate with a ball shaped valve seat 13. This may be considered as a sort of inversion of the acoustic device 100 shown in FIGS. 1A and 1B. In general, it will be understood that various aspects of the embodiments described herein can be varied, e.g. by inverting the roles/shapes of valve seat 13 and valve member 14 and/or inverting which side has the elastic material.

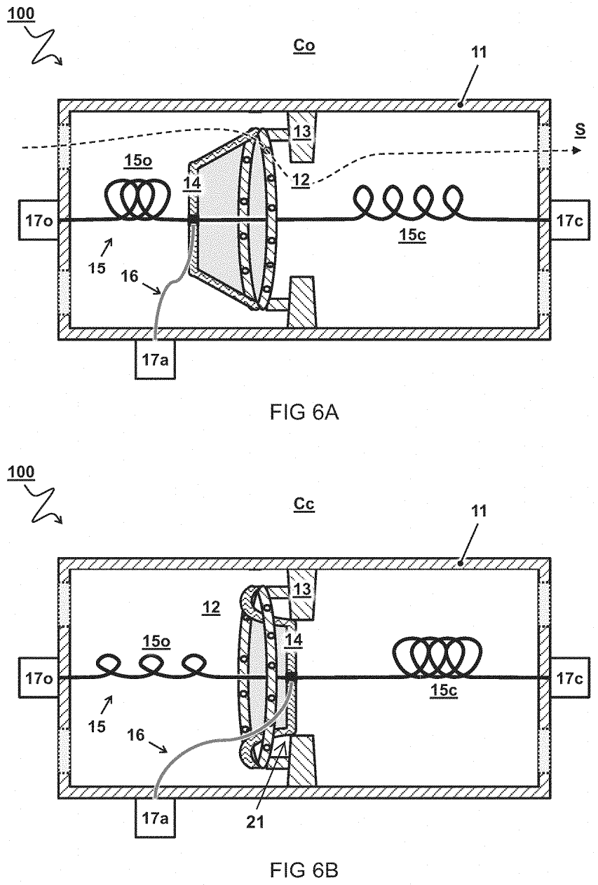

FIGS. 6A and 6B illustrate a deformable cup shaped valve member 14 being actuated with respect to the valve seat 13 forming a rim around the cup shape. In some embodiments, the valve member 14 is formed by a cup which is connected to the valve seat 13. For example, the cup folding inward or outward changes the configuration of the acoustic channel 12 between the closed configuration Cc and open configuration Co. In some embodiments, the cup, or at least the edges are of an elastic/resilient material. When the cup is folded inward, this may affect openings through the edge of the cup and thereby the passage of sound S. When folded in one direction, the flexible cup may get stuck in that configuration until it is pulled to other direction. In other embodiments, the cup may comprise a magnet or a magnetizable structure which interacts with a magnet or magnetizable structure of the valve seat 13 in order to retain or to support retention of the cup in the closed configuration Cc.

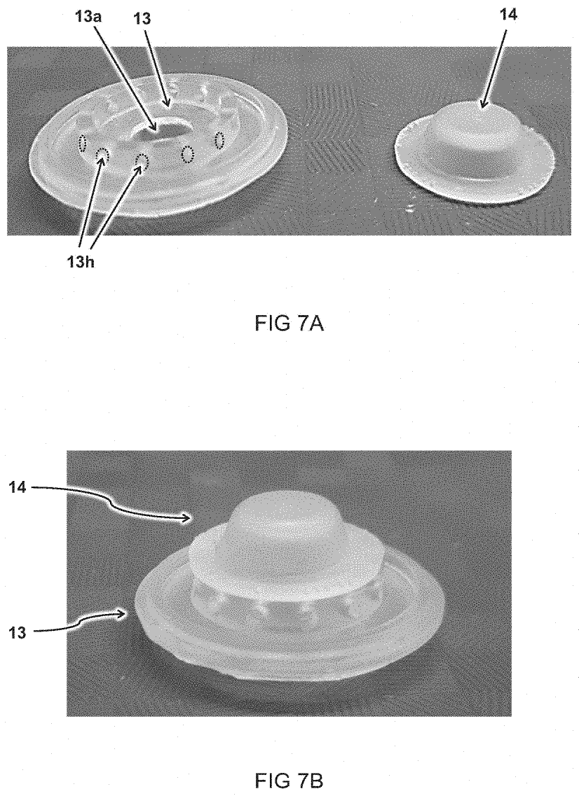

FIGS. 7A and 7B illustrate photographs of an embodiment for the deformable cup shaped valve member 14 and valve seat 13. In one embodiment, e.g. as shown, the valve seat 13 forms an aperture 13a which can be open or closed depending on a configuration of the cup shaped valve member 14. When the cup is in the open configuration, sound may pass through the aperture 13a, e.g. via holes 13h in a ring connected to a rim of the cup. For example, the ring can form a unit with the valve seat 13 and/or be part of the housing. In some embodiments, the unit comprising the valve seat 13 forming the aperture 13a and/or ring with holes 13a is of relatively hard material. Of course also other structures forming acoustic paths can be envisaged. In other or further embodiments, the cup shaped valve member 14 is of a relatively soft and/or elastic material as described herein.

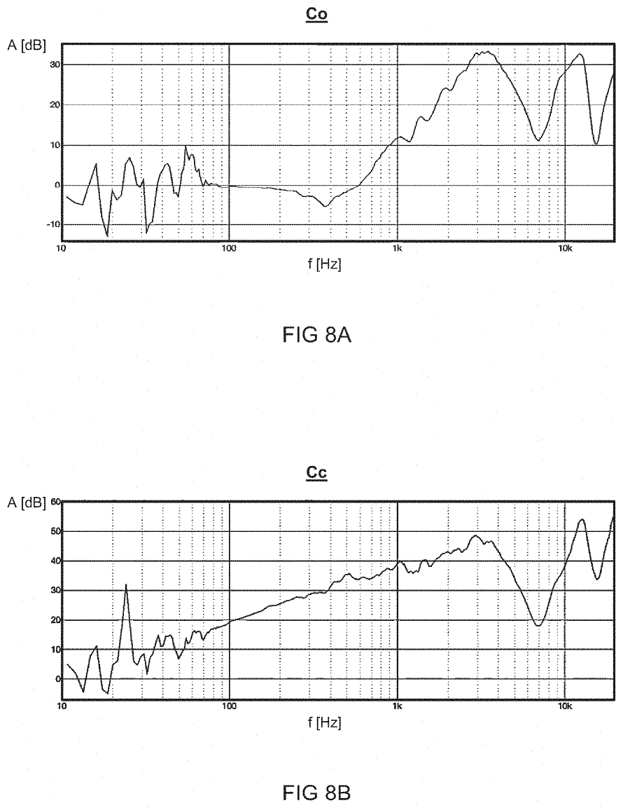

FIGS. 8A and 8B illustrate acoustic measurements of an acoustic device according to FIGS. 1A and 1B. The graphs show the attenuation “A” (in decibel) as function of frequency “f” (in Hertz). The top and figures illustrate the measurement in the open and closed configurations (Co, Cc), respectively. For example, at 200 Hz the closed configuration provides an attenuation of 25 decibel. Of course also other attenuations can be envisaged.

FIGS. 9A and 9B illustrate an acoustic device 100 wherein a disk shaped valve member 14 comprises a permanent magnet 14.1 which cooperates with a magnetizable structure 13.1 of the valve seat 13 to retain the valve member 14 in a closed configuration Cc. FIG. 9A shows the acoustic valve in a closed configuration Cc and FIG. 9B depicts the acoustic valve in an open configuration Co.

The acoustic device 100 also comprises a stopper or limiter 18 including a magnetizable structure 18.1 for retaining the valve member 14 in an open configuration Co. The acoustic device 100 of FIGS. 9A and 9B therefore provides for an acoustic valve with a bi-stable configurations, e.g. stable configurations in the open configuration Co and the closed configuration Cc. In other embodiments, the valve member 14 may comprise a magnetizable structure and the valve seat 13 and/or the stopper 18 each may comprise permanent magnets.

The acoustic valve is arranged in an elongate housing 11 having a longitudinal direction A. An acoustic channel 12 extends essentially in direction of A through the housing 11. The acoustic valve is arranged in the acoustic channel 12 and is configured to allow or block the passing of sound through the acoustic channel 12 depending on its configuration Co or Cc, respectively. The acoustic channel 12 has a sound opening 12.1 in front wall 11.1 and a sound opening 12.2 a rear wall 11.2. The sound openings 12.1 and 12.2 provide for inlet and outlet openings for sound into and from, respectively, the acoustic channel 12. In FIG. 9B, sound S is shown to enter through opening 12.2 and exit through opening 12.1 but it is understood throughout the disclosure herein that the sound S may also propagate through the acoustic device 100 in the opposite direction.

The valve member 14 is arranged between a first SMA wire section 15c and a second SMA wire section 15o. The SMA wire sections 15c, 15o are coiled-up to form helically wound (micro-)spring like structures. The SMA wire sections 15c, 15o are mechanically connected to the valve member 14. The first SMA wire section 15c for example may pull the valve member 14 towards the valve seat 13 when activated and the second SMA wire section 15o is configured to pull the valve member 14 away from the valve seat 13 and towards the stopper 18 when activated.

In some embodiments, the valve seat 13 may be provided for by a partition wall arranged in a housing 11 of the acoustic device 100. The partition wall has an opening for the passage of sound S through the acoustic channel 12 of the housing 11. The opening may be covered by the valve member 14 when in the closed configuration Cc and uncovered when the valve member is in the open configuration Co. The partition wall, in particular a border area around the opening, may thus provide a contact surface for abutment of the valve member 14 in the closed configuration Cc and, thusly, provide for the valve seat 13.

The permanent magnet 14.1 of the valve member 14 may interact magnetically with the magnetizable structure 13.1 of the valve seat 13 providing for a first attractive magnetic force Fm1 retaining the valve member 14 in the closed configuration Cc in the valve seat 13. Similarly, the permanent magnet 14.1 of the valve member 14 may interact magnetically with the magnetizable structure 18.1 of the stopper 18 providing for a second attractive magnetic force Fm2 retaining the valve member 14 in the open configuration Co at the stopper 18. The permanent magnet 14.1 of the valve member 14 and the magnetizable structures 13.1 of the valve seat 13 as well as the magnetizable structure 18.1 of the stopper 18 together provide for a retention mechanism 21 for retaining the valve member 14 in the closed configuration Cc and in the open configuration Co, respectively.

In some embodiments, the magnetizable structure 18.1 of the stopper 18 may be provided as a ring-shaped structure comprising a soft magnetic material against which the disk-shaped valve member 14 may abut in the open configuration Co.

The first magnetic force Fm1, at least in a near environment of the valve seat 13, attracts the valve member 14 towards the closed configuration Cc when the first SMA wire section 15c is activated to pull the valve member 14 towards the closed configuration Cc. In other words, the first magnetic force Fm1 exerts an attractive force towards the valve seat 13 which supports the pulling force provided by the first SMA wire section 15c in a near environment of the closed configuration Cc. In some embodiments, the first magnetic force Fm1 is (only) overcome when the second wire section 15o is activated to pull the valve member 14 towards the open configuration Co.

Similarly, the second magnetic force Fm2, at least in a near environment of the stopper 18, attracts the valve member 14 towards the open configuration Cc when the second SMA wire section 15o is activated to pull the valve member 14 towards the open configuration Co. In other words, the second magnetic force Fm2 exerts an attractive force towards the stopper 18 which supports the pulling force provided by the second SMA wire section 15o in a near environment of the open configuration Co. In some embodiments, the second magnetic force Fm2 is (only) overcome when the first wire section 15c is activated to pull the valve member 14 towards the closed configuration Cc.

The valve member 14 may comprise a coating of an elastic material 14.2 which may serve as a damping material to reduce the acoustic effects of an impact of the valve member 14 on the valve seat 13 or on the stopper 18 when transitioning into the closed configuration Co or the open configuration Co, respectively. The coating 14.2 may thus reduce potentially disturbing or irritating impact noises of the acoustic valve when switching from the open configuration Co to the closed configuration Cc and vice versa. The coating 14.2 may also be used to adjust the strengths of the first magnetic force Fm1 and/or second magnetic force Fm2 by functioning as a spacer between the permanent magnet 14.1 and the magnetizable structures 13.1 and/or 18.1, respectively. By choosing a particular thickness of the coating 14.2, the strength of the magnetic forces Fm1 and Fm2 may be adjusted according to requirements.

The housing 11 may be formed from a soft magnetic material in order to shield the ambient environment from the magnetic field of a permanent magnet or magnets inside the housing 11.

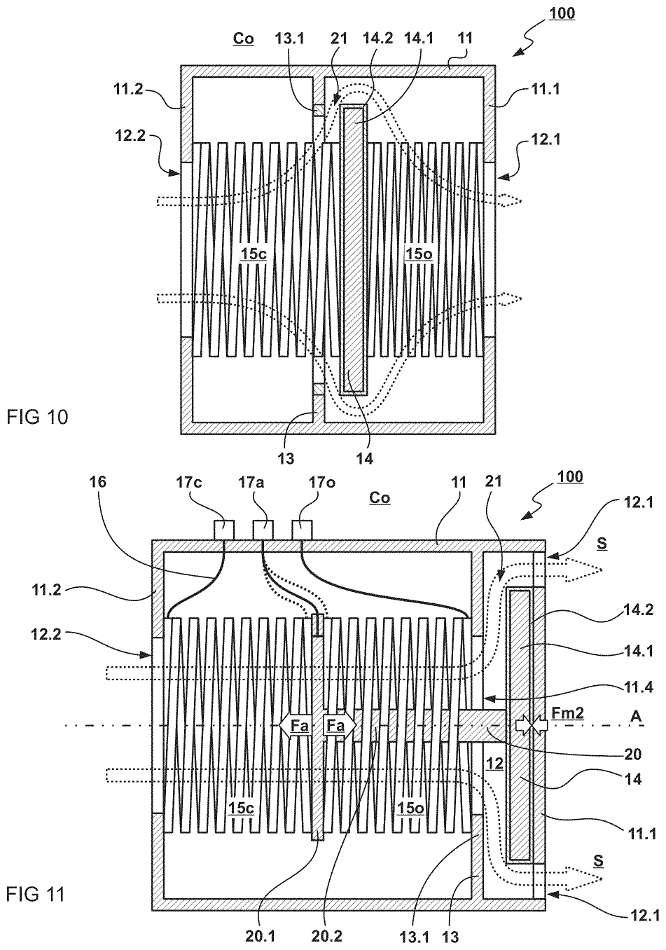

FIG. 10 illustrates an acoustic device 100 wherein a disk shaped valve member 14 comprises a permanent magnet 14.1 which cooperates with a valve seat 13 having a magnetizable structure 13.1 to retain the valve member 14 in a closed configuration Cc. The embodiment shown in FIG. 10 essentially corresponds to the acoustic device 100 depicted in FIGS. 9A and 9B with the difference that the valve member 14 is not supported or retained by a separate mechanism in the open configuration Co in the embodiment of FIG. 10.

In contrast to the embodiment of FIGS. 9A and 9B, the permanent magnet 14.1 of the valve member 14 and the magnetizable structures 13.1 of the valve seat 13 together provide for a retention mechanism 21 for retaining the valve member 14 in the closed configuration Cc only.

FIG. 11 illustrates an acoustic device 100 wherein a disk shaped valve member 14 comprises a permanent magnet 14.1 which cooperates with a valve seat 13 having a magnetizable structure 13.1 to retain the valve member 14 in a closed configuration Cc. The valve seat 13 in this embodiment is provided by a partition wall of the housing 11 which by itself provides for the magnetizable structure 13.1 in that it e.g. comprises or is formed from a magnetizable material.

The acoustic device 100 of FIG. 11 has a front wall 11.1 which acts as a stopper 18 for the valve member 14 in the open configuration Co. The front wall 11.1 for example provides for a contact surface for the valve member 14 against which it may abut in the open configuration Co. The front wall 11.1 may for example be formed by or comprise a magnetizable material 18.1 with which the permanent magnet 14.1 of the valve member 14 may magnetically interact in order to provide for a second magnetic retention force Fm2 retaining the valve member 14 in the open configuration Co. In other embodiments, the front wall 11.1 may comprise a magnetic material as e.g. one or more permanent magnets which may magnetically interact with the valve member 14.

The permanent magnet 14.1 of the valve member 14 together with the magnetizable structure 13.1 of the valve seat 13 as well as the front wall 11.1 or the magnetizable structure 18.1 thereof provide for a retention mechanism 21 for retaining the valve member 14 in the closed configuration Cc and the open configuration Co, respectively.

The front wall 11.1 has sound openings 12.1 from which sound S passing through the acoustic channel 12 may leave the housing 11. The sound S may have entered the acoustic channel 12 through sound opening 12.2. The sound openings 12.1 are arranged and configured to remain unobstructed when the valve member 14 is in the open configuration Co whereas an opening in the valve seat 13 is arranged and configured to be closed by the valve member 14 when the valve member 14 is in the closed configuration Cc.

In contrast to the embodiments of FIGS. 9A, 9B and 10, the first SMA wire section 15c and the second SMA wire section 15o of the embodiment of FIG. 11 are arranged on the same side of the valve member 14, in particular on a far side of the partition wall in the housing 11 which provides for the valve seat 13. The SMA wire sections 15c, 15o are sequentially arranged between a rear wall 11.2 of the housing 11 and the valve seat 13. An actuator plate 20.1 of an actuator linkage 20 is arranged between the SMA wire sections 15c and 15o such that an activation of the SMA wire sections 15c or 15o results in a pull force on the actuator plate 20.1 the direction of which depends on which of the SMA wire sections 15c or 15o is activated. The actuator plate 20.1 is connected via a push/pull-rod 20.2 to the valve member 14 in such a way that a longitudinal translation of the actuator plate 20.1 in direction of A results in an analogue translation of the valve member 14. The present disclosure, however, is not limited to such an embodiment and other embodiments may comprise an actuator linkage which is configured to transfer e.g. a rotational movement effected by the activation of the SMA wire sections into a longitudinal movement of the valve member or vice versa. By such arrangements, an actuator assembly may be spatially separated from a valve arrangement and have a different orientation which provides for greater flexibility for the design of the acoustic device 100.

The acoustic device 100 of the embodiment of FIG. 11 has three electric terminals 17o, 17c and 17a which are accessible from the outside of the housing 11 and which form connection points for an electric controller (not shown). The electric controller may be coupled to the terminals 17o, 17c, 17a in order to selectively supply an electric current to the SMA wire sections 15c and 15o. To this end, terminal 17c is connected to a distal end of the first SMA wire section 15c whereas terminal 17o is connected to a distal end of the second SMA wire section 15o by leads 16. Lead 16 may be provided by wires, in particular braided wires or other types of wires that may provide for good flexibility. Terminal 17a is connected to both the proximal end of the first SMA wire section 15c as well as the proximal end of the second SMA wire section 15o. “Proximal end” hereby refers to the ends of the SMA wire sections 15c, 15o that are arranged in proximity to each other, e.g. which are arranged at the actuator plate 20.1 in this embodiment.

Terminal 17a therefore forms a common terminal for both SMA wire sections 15c and 15o and the first SMA wire section 15c may be supplied by the electric controller with an electric current via terminals 17a and 17c whereas the second SMA wire section 15o may be supplied via terminals 17a and 17o.

Terminal 17a may be connected to the SMA wire sections 15c and 15o directly via separate leads 16 (dashed lines in FIG. 11) or may be connected to a distributor leads on the actuator plate 20.1. The distributor leads connect to both the SMA wire sections 15c, 15o (indicated by the solid inverted T-shaped line in FIG. 11). In other embodiments, the actuator plate 20.1 itself maybe electrically conducting in which case terminal 17a may simply connect to the actuator plate 20.1.

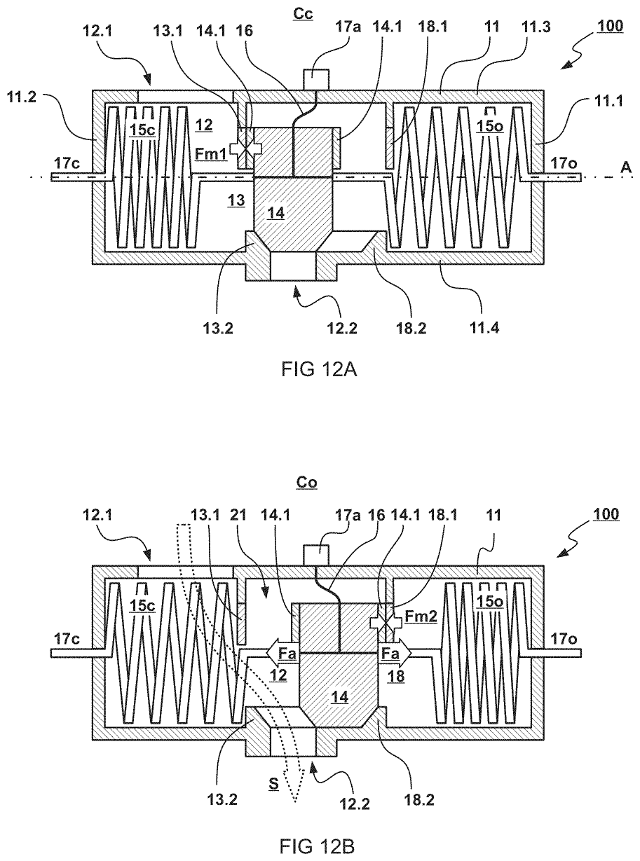

FIGS. 12A and 12B illustrate an acoustic device 100 having an essentially cylindric valve member 14 which is arranged between a first SMA wire section 15c and a second SMA wire section 15o. The SMA wire sections 15c and 15o are coiled-up and thereby accommodate a great length of wire in a limited space. The valve member 14 is displaceable between a closed configuration Cc (cf. FIG. 12A) and an open configuration Co (cf. FIG. 12B).

The acoustic device 100 of FIGS. 12A and 12B comprises an elongate housing 11 with a longitudinal direction A having a front wall 11.1 and a rear wall 11.2 with respect to the direction of A. In contrast to the arrangements of e.g. FIG. 9A, 9B, 10, 11A or 11B, an acoustic channel 12 extends from a top wall 11.3 to a bottom wall 11.4 of the housing 11, e.g. in a generally transverse direction with respect to the direction of A. The acoustic channel 12 communicates with the ambient environment via a sound opening 12.1 in the bottom wall 11.4 and a sound opening 12.2 in the top wall 11.3.

The valve member 14 is displaceable in the direction of A and push or pull forces provided by the first SMA wire section 15c and the second SMA wire section 15o to actuate the valve member 14 are directed along the direction of A. As such, the valve member 14 is displaceable in a direction essentially transverse to the general direction of the acoustic channel 12.

A valve seat 13 is e.g. provided on the inside of the housing 11 and limits the displacement of the valve member 14 in the closed configuration Cc. A stopper 18 is also provided inside the housing 11 and limits the displacement of the valve member 14 in the open configuration Co.

Valve seat 13 and stopper 18 each comprise a mechanical limiter 13.2 and 18.2, respectively, which limit the range of motion of the valve member 14 in the direction of A. The limiters 13.2 and 18.2 may for example form part of a guiding assembly for mechanically guiding the displacement of the valve member 14 between the open configuration Co and the closed configuration Cc. In some embodiments, the guiding assembly may comprise a guide groove inside of the housing 11 at the opening 12.1 with which the valve member 14 or parts of it engage.

Stopper 18 further comprises a permanent magnet 18.1 which is fixedly arranged in the housing 11 in a region at the top wall 11.3, e.g. essentially opposite the limiter 18.2 with respect to A. Valve seat 13 also comprises a permanent magnet 13.1 which is also fixedly arranged in the housing 11 in a region at the top wall 11.3, e.g. essentially opposite the limiter 13.2.

The permanent magnets 14.1 of the valve member 14 are positioned on the valve member 14 in such a manner that one of the magnets 14.1 may interact with the fixedly arranged magnet 13.1 when the valve member 14 is in the closed configuration Cc and one of the magnets 14.1 may interact with the magnet 18.1 when the valve member 14 is in the open configuration Co.

The magnets 13.1 and 18.1 which are fixedly arranged in the housing 11 and the magnets 14.1 of the valve member 14 provide for a retention mechanism 21 for retaining the valve member 14 in an open configuration Co as well as in a closed configuration Cc. The retention mechanism 21 provides for a bi-stable acoustic valve arrangement. As already described in the above, the magnetic forces provided by the retention mechanism 21 may also support the changing of the configuration of the acoustic valve.

It is to be understood that other embodiments with magnetic retention mechanisms may have different configurations or arrangements of permanent magnets, magnetizable structures and may even incorporate electromagnets which are activated for retaining the valve member in one of its desired configurations. Other embodiments may require the acoustic valve to have more than two defined configurations and may e.g. include an intermediate configuration in which the valve seat is only partially open. In these or other embodiments, acoustic valve assemblies may therefore have tri-stable or higher order multi-stable arrangements. Such embodiments may be easily conceived of based on the present disclosure.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

What is claimed is:

1. An acoustic device comprising:
a housing;
an acoustic channel for passing sound through the housing;
a valve seat arranged in the acoustic channel;
a valve member configured to control the passing of sound through the channel depending on a configuration of the valve member with respect to the valve seat;
an actuator comprising a first SMA wire section and a second SMA wire section configured to actuate the valve member and to change a configuration of the valve member with respect to the valve seat from an open configuration to a closed configuration and vice versa, respectively, when activated; and
a retention mechanism which is configured to provide a retention force for retaining the valve member in the closed configuration, wherein
the retention force is configured to be overcome by the actuator such that the valve member is released from the closed configuration upon activation of the actuator.

2. The acoustic device according to claim 1, wherein the first SMA wire section and/or the second SMA wire section is coiled to form a micro spring, wherein a distance between end points of the coiled part of the respective SMA wire section is less than an uncoiled length of the respective SMA wire section, by at least a factor three.

3. The acoustic device according to claim 1, wherein different parts of a single SMA wire form the first and second SMA wire section.

4. The acoustic device according to claim 1, wherein the first and the second wire section are arranged on either side of the valve member.

5. The acoustic device according to claim 1, wherein the first and the second wire section are arranged on the same side of the valve member.

6. The acoustic device according to claim 1, wherein the first SMA wire section and the second SMA wire section are directly connected to the valve member.

7. The acoustic device according to claim 1, wherein the first SMA wire section and/or the second SMA wire section is connected to the valve member via an actuator linkage.

8. The acoustic device according to claim 1, wherein multiple SMA wire sections are disposed on each side of the valve member.

9. The acoustic device according to claim 1, comprising a set of electric terminals which are configured to supply an electric current to the actuator for its activation.

10. The acoustic device according to claim 1, wherein the first SMA wire section and the second SMA wire section are electrically conductive and a set of electric terminals is connected to the first SMA wire section and the second SMA wire section in a manner to allow for selectively passing an electric current through the respective SMA wire section.

11. The acoustic device according to claim 1, wherein the first SMA wire section and the second SMA wire section each are configured to contract or extend depending on their temperature determined by an electrical current that may be provided to them via electric terminals to exert an actuation force on the valve member.

12. The acoustic device according to claim 11, wherein the SMA wire sections and the set of terminals are configured to selectively heat either one of the SMA wire sections when an electric current is passed through the respective SMA wire section to cause contraction in the heated wire section, wherein the contraction causes an actuation force which pulls the valve member towards the closed configuration when the first SMA wire section is heated or towards the open configuration when the second SMA wire section is heated.

13. The acoustic device according to claim 3, wherein
a first electric terminal is connected to the at least one SMA wire in a section between the first SMA wire section and second SMA wire section;
a second electric terminal is connected to an end of the first SMA wire section forming a first electrical path between the first electric terminal and the second electric terminal through the first SMA wire section;
a third electric terminal is connected to an end of the second SMA wire section forming a second electrical path between the first electric terminal and the third electric terminal through the second SMA wire section.

14. The acoustic device according to claim 1, wherein the valve member and/or the valve seat comprise an elastic damping material on surfaces which come into contact in the closed configuration.

15. The acoustic device according to claim 1, wherein the valve member is formed by a cup which is connected to the valve seat, wherein the cup folding inward or outward changes the configuration of the acoustic channel between the closed configuration and open configuration.

16. The acoustic device according to claim 1, wherein the retention mechanism is configured to provide the retention force for retaining the valve member in the closed configuration by a contact force between the valve member and the valve seat.

17. The acoustic device according to claim 16, wherein at least one of the valve member and valve seat comprises an elastic material;
wherein the valve member is dimensioned to at least partially pass through an opening formed by the valve seat, or vice versa, by compressing the elastic material when the at least one SMA wire, in particular a first SMA wire section, is activated to change to a closed configuration; wherein
the contact force between the valve seat and valve member is caused by the compressed elastic material pushing to re-expand there between.

18. The acoustic device according to claim 17, wherein at least one of the valve member and valve seat comprises the elastic material with a Young's modulus of less than two hundred Mega Pascal, and the other of the valve member and valve seat comprises a rigid material with a Young's modulus of more than four hundred Mega Pascal.

19. The acoustic device according to claim 16, wherein the valve seat comprises a ring having an inner diameter and a thickness configured to cause the valve member to remain stuck therein when the first wire section is activated to pull the valve member towards the closed configuration, and get unstuck when the second wire section is activated to pull the valve member towards the open configuration.

20. The acoustic device according to claim 1, wherein the retention mechanism comprises a magnet or magnetizable structure fixedly arranged in relation to the valve seat which is configured to interact with a corresponding magnet or magnetizable structure of the valve member in the closed configuration.

21. The acoustic device according to claim 20, wherein the valve member comprises a permanent magnet and the valve seat comprises a soft magnetic alloy as a corresponding magnetizable structure.

22. The acoustic device according to claim 21, wherein the valve member comprises a disk shaped permanent magnet and the valve seat comprises a structure which is made from a soft magnetic alloy and which has a ring-shaped contact surface for abutment of the valve member in the closed configuration.

23. The acoustic device according to claim 1, wherein the retention mechanism is configured to provide for a second retention force for retaining the valve member in the open configuration, wherein the second retention force is configured to be overcome by the actuator such that the valve member is released from the open configuration upon activation of the actuator.

24. The acoustic device according to claim 23, wherein the retention mechanism comprises
a first magnet or magnetizable structure fixedly arranged in relation to the valve seat; and
a second magnet or magnetizable structure fixedly arranged in relation to the valve seat; wherein
the first magnet or magnetizable structure and the second magnet or magnetizable structure are configured to magnetically interact with one or more magnets or magnetizable structures of the valve member in order to provide for the retention force in the closed configuration and for the second retention force in the open configuration, respectively.

25. An acoustic device comprising:
a housing;
an acoustic channel for passing sound through the housing;
a valve seat arranged in the acoustic channel;
a valve member configured to control the passing of sound through the channel depending on a configuration of the valve member with respect to the valve seat;
an actuator comprising an at least partially coiled-up SMA wire configured to actuate the valve member and to change a configuration of the valve member with respect to the valve seat from an open configuration to a closed configuration and vice versa when activated.

26. The acoustic device according to claim 25, further comprising a retention mechanism configured for retaining the valve member in the closed configuration and/or the open configuration.

27. The acoustic device according to claim 26, wherein the retention mechanism retains the valve member by a magnetic force.

28. A method for operating an acoustic device, the method comprising:
providing, by a controller unit, a first electric control signal to a first SMA wire section of an actuator of the acoustic device which is connected to a valve member to actuate the valve member to change into a closed configuration with respect to a valve seat; and
providing, by the controller unit, a second electric control signal to a second SMA wire section of the actuator of the acoustic device which is connected to the valve member to actuate the valve member to change into the open configuration with respect to the valve seat; wherein
changing into the open configuration includes the valve member to be released from the closed configuration by overcoming a retention force provided by a retention mechanism of the acoustic device.

29. The method for operating an acoustic device according to claim 28, wherein
changing into the closed configuration includes compressing an elastic material between the valve seat and the valve member; and
overcoming the retention force includes overcoming a contact force between the valve seat and the valve member caused by the compressed elastic material between the valve seat and the valve member pushing to re-expand.

30. The method for operating an acoustic device according to claim 28, wherein
changing into the closed configuration includes the valve member experiencing a magnetic force provided by the retention mechanism directed towards the closed configuration; and
being released from the closed configuration by overcoming the retention force includes overcoming the magnetic force to release the valve member from the closed configuration.

31. The method for operating an acoustic device according to claim 30, wherein
changing into the open configuration includes the valve member experiencing a second magnetic force provided by the retention mechanism towards the open configuration; and the method further including
retaining the valve member in the open configuration by a second retention force which is provided by the second magnetic force.

32. A method for operating an acoustic device, the method comprising providing, by a controller unit, an electric control signal to an at least partially coiled-up SMA wire of an actuator of the acoustic device which is connected to a valve member to actuate the valve member to change a configuration of the valve member with respect to a valve seat from an open configuration to a closed configuration and vice versa.
